(19) United States
(12) Patent Application Publication
(10) Pub. No.: US 2026/0214568 A1
(43) Pub. Date: Jul. 23, 2026

(54) Energy Saving for Radio

(71) Applicant: Telefonaktiebolaget LM Ericsson (publ), Stockholm (SE)

(72) Inventors: Fan Zhang, Beijing (CN); Huaisong Zhu, Beijing (CN); Haoyu Li, Beijing (CN); Qi Zhang, Beijing (CN); Jun Liang, Beijing (CN); Changqing Yuan, Beijing (CN)

(21) Appl. No.: 19/118,408

(22) PCT Filed: Dec. 5, 2022
(86) PCT No.: PCT/CN2022/136548

§ 371 Date: Apr. 4, 2025

(51) Int. Cl. H04W 52/02

(52) U.S. Cl. CPC H04W 52/0206

(57) ABSTRACT

The present disclosure is related to energy saving for radio. A method at an RU for energy saving comprises: transmitting, to a network node, a first message indicating one or more energy saving patterns supported by the RU; receiving, from the network node, a second message indicating at least one energy saving pattern selected from the one or more energy saving patterns; and performing one or more energy saving operations associated with the selected at least one energy saving pattern.

### TECHNICAL FIELD

The present disclosure is related to the field of wireless communication, and in particular, to a Radio Unit (RU), a network node, and methods for energy saving for radio.

### BACKGROUND

With the development of the electronic and telecommunication technologies, mobile devices, such as mobile phones, smart phones, laptops, tablets, vehicle mounted devices, become an important part of our daily lives. To support a numerous number of mobile devices, a highly power efficient Radio Access Network (RAN), such as a 5G New Radio (NR) RAN, will be required.

Carriers have been looking at energy efficiency (EE) for a few years now, but 5G will bring this to top of mind because it is going to use more energy than 4G. Some carriers spend on average 5% to 6% of their operating expenses, excluding depreciation and amortization, on energy costs, and this is expected to rise with the shift from 4G to 5G.

A typical 5G base station consumes up to twice or more the power of a 4G base station, and energy costs can grow even more at higher frequencies, due to a need for more antennas and a denser layer of small cells. Edge computing facilities needed to support local processing and new internet of things (IoT) services will also add to overall network power usage.

According to data on Remote Radio Unit (RRU)/Baseband Unit (BBU) needs per site, a typical 5G site has power needs of over 11.5 kilowatts, up nearly 70% from a base station deploying a mix of 2G, 3G, and 4G radios. 5G macro base stations may require several new, power-hungry components, including microwave or millimeter wave transceivers, field-programmable gate arrays (FPGAS), faster data converters, high-power/low-noise amplifiers and integrated MIMO antennas.

The increased power demands of a 5G base station can create several problems:
Insufficient AC power supply;
Insufficient battery capacity: more backup battery capacity is needed, yet traditional lead-acid batteries have low energy density and their capacities are difficult to expand;
Unable to support high-power long-distance transmission: in 5G scenarios requiring high power supply to remote active antenna units (AAUs), the voltage drop means that transmission distance is limited.

### SUMMARY

The introduction of high bandwidth of the 5G carrier is more than 5 times of that of the 4G carrier, and the 64/32 channel massive MIMO equipment with high complexity is mainly used outdoors, resulting in extremely higher power consumption compared with 4G network, especially RF (radio frequency) module (70%~75% of energy consumption is spent on radio side).

Currently one of the most important power saving strategy is focused on network side, such as subframe on-off, Transceivers (TRX) channel on-off, dynamic Vdd, cell sleep, and deep sleep etc. However, there is always a lack of energy-saving methods considered from the radio's perspective.

Therefore, to address or at least alleviate the above issues, some embodiments of the present disclosure propose an RU, a network node, and methods for energy saving for radio.

According to a first aspect of the present disclosure, a method at an RU for energy saving is provided. The method comprises: transmitting, to a network node, a first message indicating one or more energy saving patterns supported by the RU; receiving, from the network node, a second message indicating at least one energy saving pattern selected from the one or more energy saving patterns; and performing one or more energy saving operations associated with the selected at least one energy saving pattern.

In some embodiments, at least one of the one or more energy saving patterns is associated with multiple domains. In some embodiments, the multiple domains comprise at least one of: time domain; frequency domain; amplitude domain; and space domain. In some embodiments, an energy saving pattern is associated with a combination of one or more energy saving operations that can be performed simultaneously. In some embodiments, the combination of one or more energy saving operations comprises one or more energy saving operations for each power domain.

In some embodiments, the first message further indicates, for an energy saving pattern, at least one of: one or more loads; and one or more energy consumption values associated with the one or more loads, respectively. In some embodiments, a load is a Physical Resource Block (PRB) load indicating a ratio of a number of used PRBs to a number of total PRBs. In some embodiments, the one or more energy saving patterns supported by the RU is pre-configured or hardcoded. In some embodiments, before the step of transmitting the first message, the method further comprises: receiving, from the network node, a third message indicating a current load. In some embodiments, the one or more energy saving patterns supported by the RU are dynamically determined by the RU based on at least a current load and/or one or more RU hardware capabilities. In some embodiments, a combination of one or more energy saving operations associated with an energy saving pattern is dynamically adjustable based on at least a current configuration and/or a real time status for the RU. In some embodiments, the real time status comprises at least one of: the current load; the current hardware (HW) reliability status; one or more current hardware capabilities and status; and one or more component temperatures.

In some embodiments, the one or more energy saving patterns supported by the RU are all energy saving patterns that are supported by the RU with the current hardware capability at the current load. In some embodiments, the at least one energy saving pattern indicated by the second message is selected based on at least one of: one or more Key Performance Indicators (KPIs); and a current load. In some embodiments, the at least one energy saving pattern is at least one of the one or more energy saving patterns that is associated with the lowest power consumption of the RU at the current load.

In some embodiments, an energy saving operation and/or power domain is associated with at least one of: a Central Processing Unit (CPU); one or more Layer 1 Beam Formers (L1BFs); one or more Digital Front End (DFEs); one or more receiver Analog Front End (RX-AFEs); one or more transmitter Analog Front End (TX-AFEs); and one or more TRX. In some embodiments, an energy saving operation is an operation associated with at least one of: Crest Factor Reduction (CFR) adjustment; TRX channel shutdown; TRX channel standby; TRX shutdown; DFE clock gating; DFE channel standby; DFE channel shutdown; DFE shutdown; L1BF clock gating; L1BF shutdown; Power Amplifier (PA) VDD adjustment; PA bias adjustment; PA blinking; PA shutdown; Low Noise Amplifier (LNA) blinking; Dynamic Voltage and Frequency Scaling (DVFS); Application Specific Integrated Chip (ASIC) dynamic clock gating; Data bus speed optimization; Digital Pre-distortion (DPD) disabling; and Local Area Network (LAN) blinking.

According to a second aspect of the present disclosure, an RU is provided. The RU comprises: a processor; a memory storing instructions which, when executed by the processor, cause the processor to perform any of the methods of the first aspect.

According to a third aspect of the present disclosure, an RU for energy saving is provided. The RU comprises: a transmitting module configured to transmit, to a network node, a first message indicating one or more energy saving patterns supported by the RU; a receiving module configured to receive, from the network node, a second message indicating at least one energy saving pattern selected from the one or more energy saving patterns; and a performing module configured to perform one or more energy saving operations associated with the selected at least one energy saving pattern. In some embodiments, the RU comprises one or more further modules, each of which performs any of the steps of any of the methods of the first aspect.

According to a fourth aspect of the present disclosure, a method at a network node for facilitating an RU in energy saving is provided. The method comprises: receiving, from the RU, a first message indicating one or more energy saving patterns supported by the RU; selecting at least one of the one or more energy saving patterns; and transmitting, to the RU, a second message indicating the selected at least one energy saving pattern.

In some embodiments, an energy saving pattern is associated with a combination of one or more energy saving operations that can be performed by the RU simultaneously. In some embodiments, the first message further indicates, for an energy saving pattern, at least one of: one or more loads; and one or more energy consumption values associated with the one or more loads, respectively. In some embodiments, a load is a PRB load indicating a ratio of a number of used PRBs to a number of total PRBs. In some embodiments, before the step of receiving the first message, the method further comprises: transmitting, to the RU, a third message indicating a current load. In some embodiments, the at least one energy saving pattern is selected based on at least one of: one or more KPIs; and a current load. In some embodiments, the at least one energy saving pattern is at least one of the one or more energy saving patterns that is associated with the lowest power consumption of the RU at the current load.

In some embodiments, an energy saving operation and/or power domain is associated with at least one of: a CPU; one or more L1BFs; one or more DFEs; one or more RX-AFEs; one or more TX-AFEs; and one or more TRX. In some embodiments, an energy saving operation is an operation associated with at least one of: CFR adjustment; TRX channel shutdown; TRX channel standby; TRX shutdown; DFE clock gating; DFE channel standby; DFE channel shutdown; DFE shutdown; L1BF clock gating; L1BF shutdown; PA VDD adjustment; PA bias adjustment; PA blinking; PA shutdown; LNA blinking; DVFS; ASIC dynamic clock gating; Data bus speed optimization; DPD disabling; and LAN blinking. In some embodiments, the network node comprises at least one of: Service Management and Orchestration (SMO); BBU; and DU.

According to a fifth aspect of the present disclosure, a network node is provided. The network node comprises: a processor; a memory storing instructions which, when executed by the processor, cause the processor to perform any of the methods of the fourth aspect.

According to a sixth aspect of the present disclosure, a network node for facilitating an RU in energy saving is provided. The network node comprises: a receiving module configured to receive, from the RU, a first message indicating one or more energy saving patterns supported by the RU; a selecting module configured to select at least one of the one or more energy saving patterns; and a transmitting module configured to transmit, to the RU, a second message indicating the selected at least one energy saving pattern. In some embodiments, the network node comprises one or more further modules, each of which performs any of the steps of any of the methods of the fourth aspect.

According to a seventh aspect of the present disclosure, a computer program comprising instructions is provided. The instructions, when executed by at least one processor, cause the at least one processor to carry out any of the methods of the first and/or the fourth aspects.

According to an eighth aspect of the present disclosure, a carrier containing the computer program of the seventh aspect is provided. In some embodiments, the carrier is one of an electronic signal, optical signal, radio signal, or computer readable storage medium.

According to a ninth aspect of the present disclosure, a telecommunication system is provided. The telecommunication system comprises: one or more RUs; and at least one network node, wherein at least one of the RUs and the at least one network node are configured to: transmit, from the RU to the network node, a first message indicating one or more energy saving patterns supported by the RU; select, by the network node, at least one of the one or more energy saving patterns; transmit, from the network node to the RU, a second message indicating the selected at least one energy saving pattern; and perform, by the RU, one or more energy saving operations associated with the selected at least one energy saving pattern. In some embodiments, the one or more RUs are RUs of the second or third aspect. In some embodiments, the at least one network node is a network node of the fifth or sixth aspect.

With some embodiments of the present disclosure, by using the energy saving information provided by radio, a RAN node (e.g., a DU and/or a BBU) or even network management node (e.g., an APP in SMO) can calculate radio power consumption on different scenarios (e.g., alarm, temperature, PRB loads). After considering the different scenarios (e.g., network KPIs and/or UE impact), the optimal energy saving operation(s) for power saving can be chosen. Besides, some embodiments of the present disclosure may prepare for diverse hardware platform and software evolution in the future. Further, a large amount of reserve data can be obtained by lab tests to prepare for machine learning in the near future. This is beneficial for improving data process and preparation.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and therefore are not to be considered limiting of its scope, the disclosure will be described with additional specificity and detail through use of the accompanying drawings.

FIG. 1 is a diagram illustrating how to achieve optimal energy consumption with multiple EE functions according to an embodiment of the present disclosure.

FIG. 2 is a diagram illustrating an exemplary system for energy saving for radio according to an embodiment of the present disclosure.

FIG. 3 is a diagram illustrating an exemplary radio hardware resource pool according to an embodiment of the present disclosure.

FIG. 4 is a diagram illustrating an exemplary mapping between energy saving features, power domains, and energy saving operations according to an embodiment of the present disclosure.

FIG. 5 is a diagram illustrating an exemplary radio hardware abstraction format definition according to an embodiment of the present disclosure.

FIG. 6 is a diagram illustrating an exemplary procedure for energy saving for radio according to an embodiment of the present disclosure.

FIG. 7 is a diagram illustrating exemplary cross point gains according to an embodiment of the present disclosure.

FIG. 8 is a flow chart illustrating an exemplary method at an RU for energy saving according to an embodiment of the present disclosure.

FIG. 9 is a flow chart illustrating an exemplary method at a network node for facilitating an RU in energy saving according to an embodiment of the present disclosure.

FIG. 10 schematically shows an embodiment of an arrangement which may be used in an RU or a network node according to an embodiment of the present disclosure.

FIG. 11 is a block diagram of an exemplary RU according to an embodiment of the present disclosure.

FIG. 12 is a block diagram of an exemplary network node according to an embodiment of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first”, “second”, “third”, “fourth,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5G New Radio (NR), the present disclosure is not limited thereto. In fact, as long as energy saving for radio is involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA

(WCDMA), Time Division-Synchronous CDMA (TD-SCDMA), CDMA2000, Worldwide Interoperability for Microwave Access (WiMAX), Wireless Fidelity (Wi-Fi), 4th Generation Long Term Evolution (LTE), LTE-Advance (LTE-A), or 5th Generation New Radio (5G NR), etc. Therefore, one skilled in the arts could readily understand that the terms used herein may also refer to their equivalents in any other infrastructure. For example, the term “User Equipment” or “UE” used herein may refer to a terminal device, a mobile device, a mobile terminal, a mobile station, a user device, a user terminal, a wireless device, a wireless terminal, or any other equivalents. For another example, the term “network node” used herein may refer to a base station, a base transceiver station, an access point, a hot spot, a NodeB, an Evolved NodeB, a gNB, a BBU, a DU, a CU, a network element, a network function, an O&M node, or any other equivalents.

As mentioned above, energy-saving methods for radio (e.g., an RU) are needed. Legacy solutions of enabling/disabling RU energy saving methods are listed as follows:
1. View all energy saving methods as being independent of each other. For example, a decision of TRX channel on or off has no impact on a strategy of Dynamic Vdd adjustment.
2. Enabling/disabling RU energy saving methods only relies on cell load. For example, if a cell load is lower than a certain threshold, a specific power saving method could be enabled.

Unfortunately, legacy solutions do not work well due to:
1. Temperature not aware: radio is a temperature sensitive equipment and temperature will have different impacts on each energy saving solution.
2. Radio Platform not aware: A radio hardware platform evolves continuously, and it will have different energy saving methods on different hardware platforms.
3. Not flexible to radio configurations: when providing services, there could be many configurations on carrier. The configurations for radio branches, maximum power needed per port, carrier bandwidth etc. could have big margin or create various sleep depths or opportunities on power consumption. However, detailed behaviours of radio hardware resources and corresponding energy consumptions are imperceptible to DU/BB and high-layer network software, whose processing granularity is cell instead of radio. This will cause energy saving loss due to BB and Radio function dispatching.
4. Coupled power saving methods due to resource conflict, or in other words, energy saving from different methods may be dependent. For example, switching TRX channel off will impact the optimal load threshold of Dynamic Vdd.

Therefore, how to systemize and define an effective joint optimized energy performance solution is not covered by legacy solutions yet. Some embodiments of the present disclosure propose a new method to enable/disable multiple RU power saving methods.

In some embodiments of the present disclosure, following operations are provided:
1. Exhaustively list all possible combinations of energy saving method on-off. In some embodiments, a combination may be also referred to as a “pattern” or an “orchestration”, and these terms can be used interchangeably.
2. Radio unit will measure/store hardware abstraction for each energy saving pattern with following information:
   different loads; and
   energy consumption value for each load.
3. Inform this information to BB/SMO App for energy saving decision.

In some embodiments, no matter digital part or analog part, for radio specific hardware behaviour and corresponding energy consumption, only radio knows itself best. Therefore, this PRB load based power consumption information for each energy saving pattern can be transferred to peer end, for example, in the form of database.

In some embodiments, via for example tests in the laboratory, several groups of energy-saving curves for each energy saving pattern (including each energy saving function or multiple energy saving functions on combinations) will be obtained. With this information, BB/SMO App could find the cross points in various RAN scenarios.

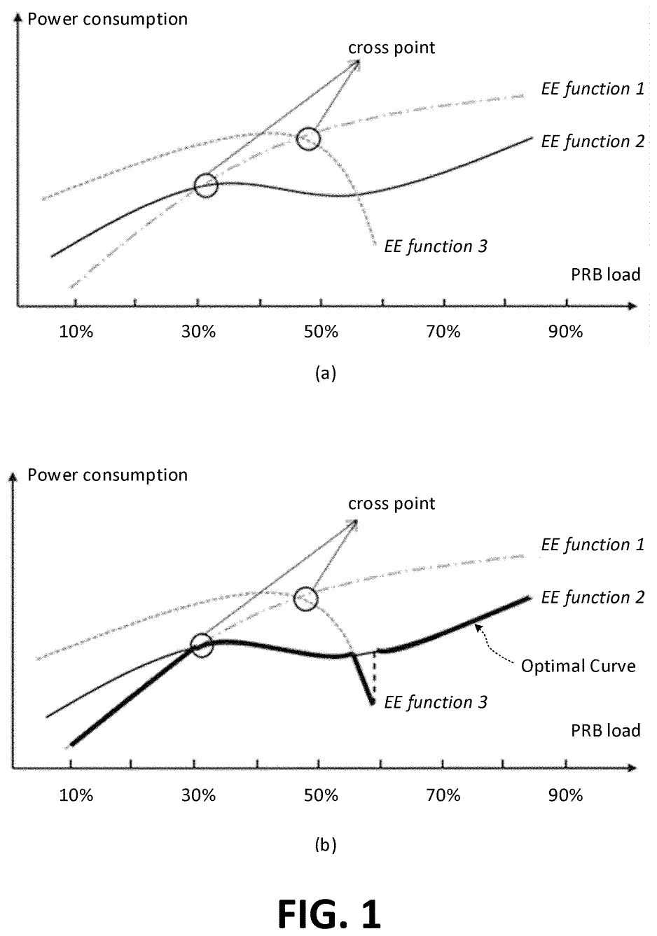

FIG. 1 is a diagram illustrating how to achieve optimal energy consumption with multiple EE functions according to an embodiment of the present disclosure. As shown in FIG. 1, an EE function may have variable performances (e.g., power consumption) at different PRB loads. For example, as shown in (a) of FIG. 1, the EE function 1 may have the lowest power consumption among all three EE functions in a range between the PRB load of about 10% to the PRB load of about 32%. Further, the EE function 2 may have the lowest power consumption among all three EE functions in a range between the PRB load of about 32% to the PRB load of about 56%. Furthermore, the EE function 3 may have the lowest power consumption among all three EE functions in a range between the PRB load of about 56% to the PRB load of about 59%. Assuming there is no recovery time for or resource conflict between these EE functions, then an optimal power consumption can be achieved by a segmented curve, which is composed of the optimal parts of different curves (e.g., the curves for the EE function 1, the EE function 2, and the EE function 3) in respective ranges, as shown in (b) of FIG. 1.

Although only curves for three individual EE functions are shown in FIG. 1, the present disclosure is not limited thereto. In some other embodiments, curves for one or more combinations (or patterns or orchestrations) of EE functions can be provided. In such a case, cross points for these curves can be determined similarly and therefore an optimal energy consumption can be achieved based on the determined cross points similarly.

In some embodiments of the present disclosure, a PRB load based radio hardware abstraction for energy saving is proposed, which may cover behaviours of diverse hardware EE operations, also called hardware orchestration. In some embodiments, the PRB load based radio hardware abstraction for energy saving may include at least one of:
Radio power domain division (CPU, L1BF, DFE, TRX, TX AFE, RX AFE etc.);
Radio hardware resource pool definition (prepared for future HW platform and software (SW) evolution);
Radio hardware energy saving capacity (recovery time and PRB based power consumption).

With some embodiments of the present disclosure, by using the energy saving information provided by radio, a RAN (e.g., a DU and/or a BBU) or even an APP in SMO for instance can calculate radio power consumption on different scenarios and PRB loads. After considering network KPIs and UE impact, the optimal energy saving operation(s) for power saving can always be chosen. Besides, some embodiments of the present disclosure may prepare for diverse hardware platform and software evolution in the future. Further, a large amount of reserve data can be obtained by lab tests to prepare for machine learning in the near future. This is beneficial for improving data process and preparation.

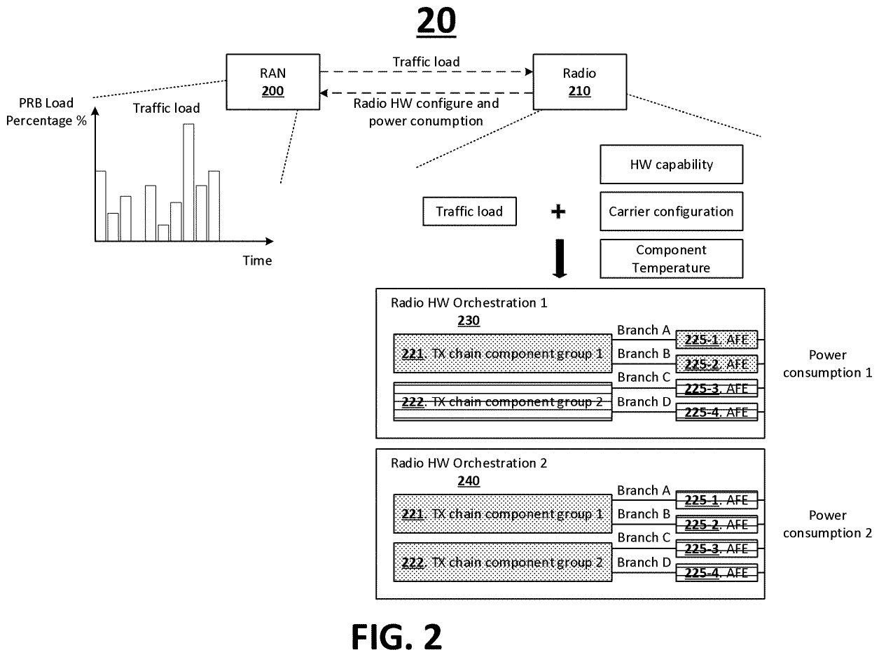

FIG. 2 is a diagram illustrating an exemplary system 20 for energy saving for radio according to an embodiment of the present disclosure. As shown in FIG. 2, the system 20 may comprise a RAN node (for example, a base station, a Node B, an eNB, an Integrated Access and Backhaul (IAB) node, a gNB, a BBU, a Central Unit (CU), or a DU) 200 and a Radio Unit (RU) 210. In some embodiments, the RU 210 may be a part of the RAN node 200 (e.g., when the RAN node 200 is a base station, an eNB, a gNB).

In some embodiments, the RU 210 may be separately located from the RAN node 200 (e.g., when the RAN node 200 is a BBU, a CU, or a DU). However, the present disclosure is not limited thereto. In some other embodiments, the system 20 may comprise a network node (for example, an SMO) 200 and an RU 210. In fact, the RAN node 200 or the SMO 200 can be replaced with any network node as long as the network node can function as follows.

Referring to FIG. 2, the network node 200 may monitor or otherwise determine the traffic loads (e.g., the PRB load percentage) at different times, and it may provide such traffic load information to the RU 210. The RU 210 may then determine one or more radio HW orchestrations or patterns that may be supported by the RU 210 at the indicated traffic loads (for example, the radio HW orchestration 1 230 and the radio HW orchestration 2 240 shown in FIG. 2) based on at least its HW capability, its carrier configuration, and/or its component temperatures. For example, the radio HW orchestration 1 230 may function well when the PRB load percentage is low since its TX chain component group 2 222 may be disabled and corresponding AFEs 225-3 and 225-4 may be correspondingly adjusted for energy saving. For another example, the radio HW orchestration 2 240 may function well when the PRB load percentage is high since all of its TX chain component groups 1 221 and 2 222 are enabled with merely some adjustments of corresponding AFEs 225-3 and 225-4 for energy saving.

Once the supported radio HW orchestrations are determined, one or more corresponding radio HW configurations can be reported to the network node 200 together with their corresponding power consumptions (e.g., the power consumption 1 for the radio HW orchestration 1 230 and/or the power consumption 2 for the radio HW orchestration 2 240) such that the network node 200 may select one of them based on one or more considerations from the network node 200's perspective, for example, based on one or more expected KPIs and/or expected energy consumption to be achieved by the network node 200.

In some embodiments, the term “KPI” used herein may represent the end-user perception of a network on a macro level. Operators may use KPI statistics to compare networks against each other, and/or to detect problems and errors.

For example, KPI may include at least one of (but not limited to):
Accessibility, including connection setup success ratio, random access ratio etc.
Retainability, including session time normalized loss ratio etc.
Integrity, including average UE latency, UE throughput, package loss ratio etc.
Mobility, including handover success rate etc.
Availability, including cell availability etc.

In some embodiments, an operator may have specific requirement(s) on KPI, for example, mobility KPI handover success rate >98%. This requirement may be set based on the operator's own business consideration.

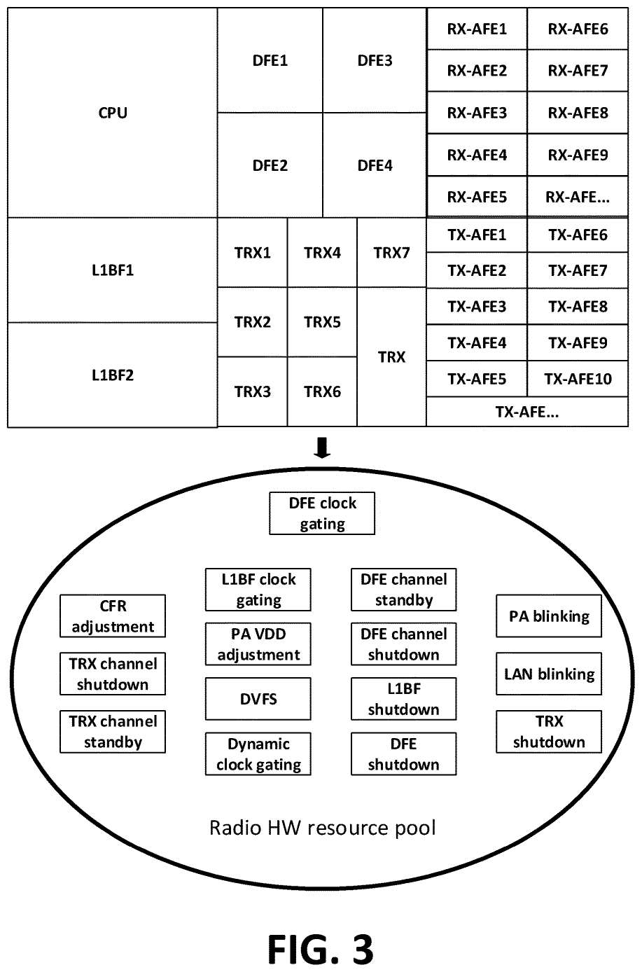

As shown in FIG. 2, all the hardware orchestration methods, either on-off control or voltage/current/threshold scaling etc. may be selected from the radio hardware resource pool (e.g., the resource pool shown in FIG. 3), which may be predefined for a specific radio platform in some embodiments.

In some embodiments, the RU 210 may report all possible radio HW configurations (or patterns) and corresponding power consumptions without considering the traffic loads indicated by the network node 200. In some embodiments, the RU 210 may further report information including (but not limited to) at least one of the HW capability of the RU 210, the carrier configuration of the RU 210, and the component temperature of the RU 210 to the network node 200, such that the network node 200 may select one of the reported radio HW configurations for the RU 210 to enforce based on the reported information and/or the network node 200's own considerations.

FIG. 3 is a diagram illustrating an exemplary radio hardware resource pool according to an embodiment of the present disclosure. As shown in FIG. 3, all the HWs of an exemplary RU can be listed as shown in the top portion of FIG. 3, and then a radio HW resource pool can be determined based thereon as shown in the bottom portion of FIG. 3. For example, for each piece of HWs and/or each type of HWs, one or more energy saving operations related thereto can be considered as a resource in the pool. For example, for each TRX channel (e.g., TRX1, TRX2, . . . ), an energy saving operation “TRX channel shutdown” and “TRX channel standby” may be determined as resources in the pool. Further, for all TRX channels, an energy saving operation “TRX shutdown” may be determined as a resource in the pool.

In some embodiments, take 64/32 branches Advanced Antenna System (AAS) radio for example, as the current device integration is getting higher and higher, it is relatively easy to define the hardware resource pool of the radio for EE orchestration. In some embodiments, this is also the definition of all possible operations in terms of energy saving from radio's perspective. Ultimately, they may orchestrate alone or in combination. It depends on current configuration and real time status of the access network.

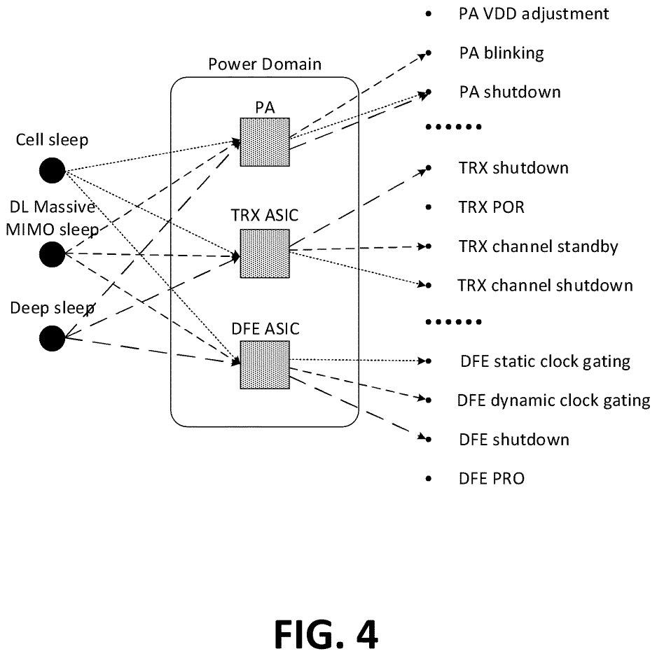

Furthermore, no matter what feature (e.g., cell sleep, power backoff, MIMO sleep/massive MIMO sleep, etc.) is used for specific power saving, it will eventually be reflected in the operation of some hardware of the RU. A simple example of connecting them to different power domains is shown in FIG. 4.

FIG. 4 is a diagram illustrating an exemplary mapping between energy saving features, power domains, and energy saving operations according to an embodiment of the present disclosure. As shown in FIG. 4, each of the different energy saving features, such as the cell sleep feature, the DL Massive MIMO sleep feature, the deep sleep feature, may be mapped to different power domains, such as PA, TRX ASIC, DFE ASIC, etc., and then further mapped to one or more energy saving operations in each power domain, such as, PA VDD adjustment in the PA power domain, TRX shutdown in the TRX power domain. Therefore, an energy saving feature can be associated with or mapped to one or more specific energy saving operations in different power domains.

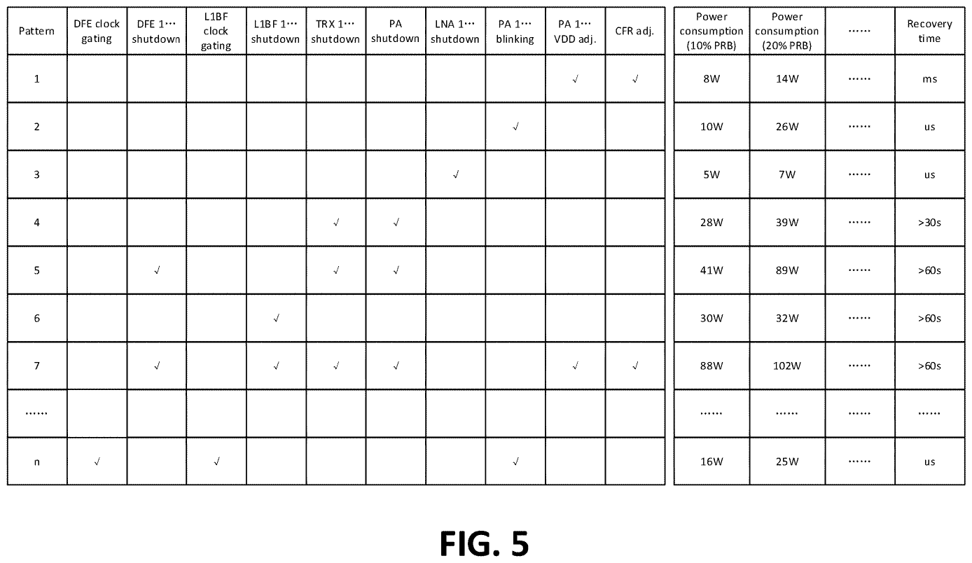

FIG. 5 is a diagram illustrating an exemplary radio hardware abstraction format definition according to an embodiment of the present disclosure. As shown in the table in FIG. 5, each row or pattern may represent an EE orchestration extracted from the HW resource pool and the one or more columns on the right are the energy consumption values under each PRB load (from idle (e.g., 10% PRB) to the full load (e.g., 100% PRB)) and also the recovery time for the patterns. For example, the pattern 1 is associated with energy saving operations “PA 1 VDD adjustment” and “CFR adjustment”, and when it is applied, power consumption for a corresponding radio unit can be expected to be reduced by 8 watts when the PRB load percentage is 10% and 14 watts when the PRB load percentage is 20%.

In some embodiments, such a table can be predetermined in an RU, for example, in its production or manufacture stage, or can be updated or otherwise configured when it is connected to a network and activated (e.g., when it is provisioned or when its firmware or software is upgraded). In some embodiments, such a table can be provided to a network node (e.g., the network node 200 shown in FIG. 2) for the network node to select an optimal pattern to be enforced at the radio unit. In some embodiments, a part of such a table can be selected based on the current load and provided to a network node (e.g., the network node 200 shown in FIG. 2) for the network node to select an optimal pattern to be enforced at the radio unit. In some embodiments, such a table for an RU may be even predetermined or configured at a network node, and no actual table needs to be provided by the RU to the network node as long as the network node can determine that this table is associated with the RU.

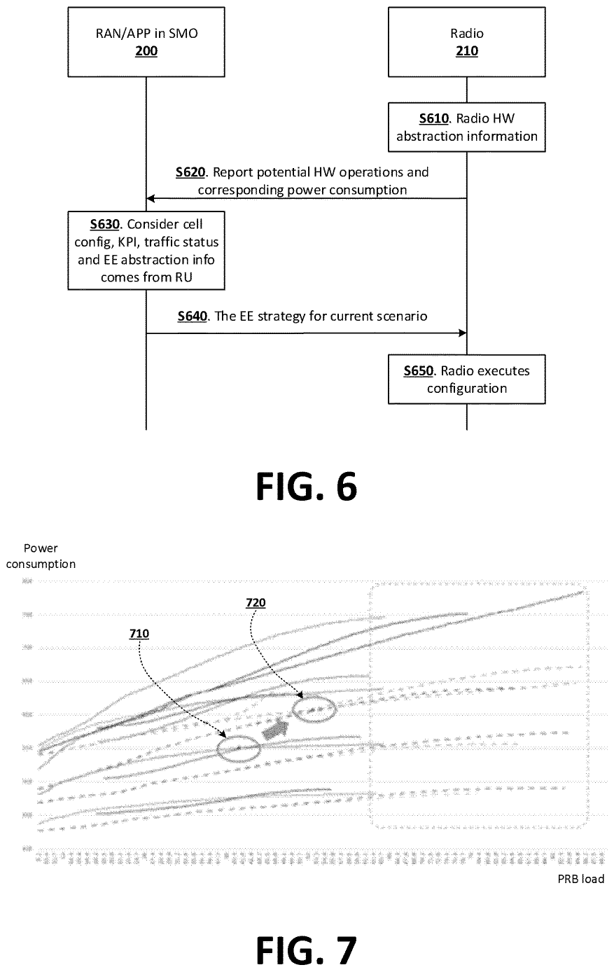

FIG. 6 is a diagram illustrating an exemplary procedure for energy saving for radio according to an embodiment of the present disclosure. The procedure may begin with step S610 where the radio (e.g., the RU 210) may exhaustively list available HW energy saving patterns and corresponding power consumptions based on traffic load and Radio HW capability (and/or other related information). At step S620, the RU 210 may report the potential hardware operations and corresponding power consumptions towards the network node 200 (e.g., a DU/a BB or an APP in an SMO) for instance.

At step S630, the network node 200 may select, based on cell configurations, KPIs, traffic status, and/or the received EE abstraction information, which EE combination (or the pattern) is the best according to the cross points information, e.g., cross points information similar to those shown in FIG. 1 or FIG. 7.

At step S640, the network node 200 may dispatch the energy saving decision to the RU 210, and at step S650, the RU 210 may execute the selected EE combination.

There are existing projects working on this, and from the lab test results so far at least, good expectations were achieved, for example, as shown in FIG. 7.

FIG. 7 is a diagram illustrating exemplary cross point gains according to an embodiment of the present disclosure. In FIG. 7, the X-axis refers to PRB load while the Y-axis refers to power consumption of an RU. As shown in FIG. 7, power consumptions for different EE combinations in different scenarios are provided, and cross points (e.g., the cross points 710 and 720) therebetween can be identified.

For example, as indicated by the cross point 710, in a specific scenario (e.g., burst traffic), a first EE pattern may function better when the PRB load percentage is lower than about 41.6% while a second EE pattern may function better when the PRB load percentage is higher than about 41.6%. In such a case, the EE pattern to be enforced at the RU may be switched from the first to the second when the PRB load percentage becomes higher than 41.6% and switched back from the second to the first when the PRB load percentage becomes lower than 41.6%.

Similarly, as indicated by the cross point 720, in another specific scenario (e.g., heavy traffic), a third EE pattern may function better when the PRB load percentage is lower than about 53.3% while a fourth EE pattern may function better when the PRB load percentage is higher than about 53.3%. In such a case, the EE pattern to be enforced at the RU may be switched from the third to the fourth when the PRB load percentage becomes higher than 53.3% and switched back from the fourth to the third when the PRB load percentage becomes lower than 53.3%.

Further, when RAN traffic is changed from burst traffic to heavy traffic, the EE pattern to be enforced at the RU may be switched from the first/second to the third when the PRB load percentage is lower than 53.3% and to the fourth when the PRB load percentage is higher than 53.3%. Furthermore, when RAN traffic is changed from heavy traffic to burst traffic, the EE pattern to be enforced at the RU may be switched from the third/fourth to the first when the PRB load percentage is lower than 41.6% and to the second when the PRB load percentage is higher than 41.6%.

Therefore, with some embodiments of the present disclosure, by using the energy saving information provided by radio, a RAN (e.g., a DU and/or a BBU) or even an APP in SMO for instance can calculate radio power consumption on different scenarios and PRB loads. After considering network KPIs and UE impact, the optimal energy saving operation(s) for power saving can always be chosen. Besides, some embodiments of the present disclosure may prepare for diverse hardware platform and software evolution in the future. Further, a large amount of reserve data can be obtained by lab tests to prepare for machine learning in the near future. This is beneficial for improving data process and preparation.

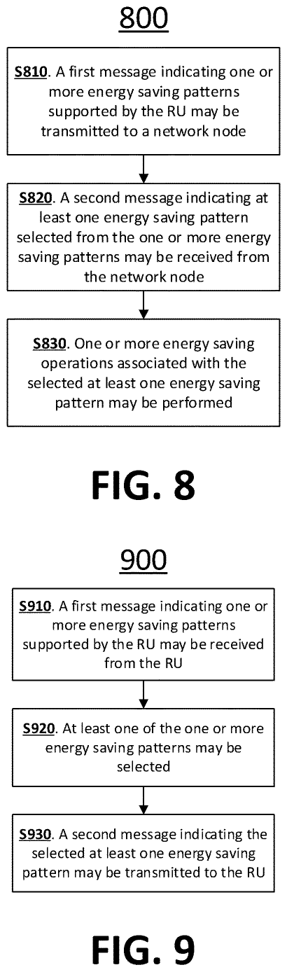

FIG. 8 is a flow chart of an exemplary method 800 at an RU for energy saving according to an embodiment of the present disclosure. The method 800 may be performed at an RU (e.g., the RU 210). The method 800 may comprise steps S810, S820, and S830. However, the present disclosure is not limited thereto. In some other embodiments, the method 800 may comprise more steps, less steps, different steps or any combination thereof. Further the steps of the method 800 may be performed in a different order than that described herein. Further, in some embodiments, a step in the method 800 may be split into multiple sub-steps and performed by different entities, and/or multiple steps in the method 800 may be combined into a single step. The method 800 may begin at step S810, where a first message indicating one or more energy saving patterns supported by the RU may be transmitted to a network node.

At step S820, a second message indicating at least one energy saving pattern selected from the one or more energy saving patterns may be received from the network node.

At step S830, one or more energy saving operations associated with the selected at least one energy saving pattern may be performed.

In some embodiments, at least one of the one or more energy saving patterns may be associated with multiple domains. In some embodiments, the multiple domains may comprise at least one of: time domain; frequency domain; amplitude domain; and space domain. In some embodiments, an energy saving pattern may be associated with a combination of one or more energy saving operations that can be performed simultaneously. In some embodiments, the combination of one or more energy saving operations may comprise one or more energy saving operations for each power domain.

In some embodiments, the first message may further indicate, for an energy saving pattern, at least one of: one or more loads; and one or more energy consumption values associated with the one or more loads, respectively. In some embodiments, a load may be a PRB load indicating a ratio of a number of used PRBs to a number of total PRBs. In some embodiments, the one or more energy saving patterns supported by the RU may be pre-configured or hardcoded. In some embodiments, before the step of transmitting the first message, the method 800 may further comprise: receiving, from the network node, a third message indicating a current load. In some embodiments, the one or more energy saving patterns supported by the RU may be dynamically determined by the RU based on at least a current load and/or one or more RU hardware capabilities. In some embodiments, a combination of one or more energy saving operations associated with an energy saving pattern may be dynamically adjustable based on at least a current configuration and/or a real time status for the RU. In some embodiments, the real time status may comprise at least one of: the current load; the current HW reliability status; one or more current hardware capabilities and status; and one or more component temperatures.

In some embodiments, the one or more energy saving patterns supported by the RU may be all energy saving patterns that are supported by the RU with the current hardware capability at the current load. In some embodiments, the at least one energy saving pattern indicated by the second message may be selected based on at least one of: one or more KPIs; and a current load. In some embodiments, the at least one energy saving pattern may be at least one of the one or more energy saving patterns that is associated with the lowest power consumption of the RU at the current load.

In some embodiments, an energy saving operation and/or power domain may be associated with at least one of: a CPU; one or more L1BFs; one or more DFEs; one or more RX-AFEs; one or more TX-AFEs; and one or more TRX. In some embodiments, an energy saving operation may be an operation associated with at least one of: CFR adjustment; TRX channel shutdown; TRX channel standby; TRX shutdown; DFE clock gating; DFE channel standby; DFE channel shutdown; DFE shutdown; L1BF clock gating; L1BF shutdown; PA VDD adjustment; PA bias adjustment; PA blinking; PA shutdown; LNA blinking; DVFS; ASIC dynamic clock gating; Data bus speed optimization; DPD disabling; and LAN blinking.

FIG. 9 is a flow chart of an exemplary method 900 at a network node for facilitating an RU in energy saving according to an embodiment of the present disclosure. The method 900 may be performed at a network node (e.g., the RAN or SMO 200). The method 900 may comprise steps S910, S920, and S930. However, the present disclosure is not limited thereto. In some other embodiments, the method 900 may comprise more steps, less steps, different steps or any combination thereof. Further the steps of the method 900 may be performed in a different order than that described herein. Further, in some embodiments, a step in the method 900 may be split into multiple sub-steps and performed by different entities, and/or multiple steps in the method 900 may be combined into a single step.

The method 900 may begin at step S910, where a first message indicating one or more energy saving patterns supported by the RU may be received from the RU.

At step S920, at least one of the one or more energy saving patterns may be selected.

At step S930, a second message indicating the selected at least one energy saving pattern may be transmitted to the RU.

In some embodiments, an energy saving pattern may be associated with a combination of one or more energy saving operations that can be performed by the RU simultaneously. In some embodiments, the first message may further indicate, for an energy saving pattern, at least one of: one or more loads; and one or more energy consumption values associated with the one or more loads, respectively. In some embodiments, a load may be a PRB load indicating a ratio of a number of used PRBs to a number of total PRBs. In some embodiments, before the step of receiving the first message, the method 900 may further comprise: transmitting, to the RU, a third message indicating a current load. In some embodiments, the at least one energy saving pattern may be selected based on at least one of: one or more KPIs; and a current load. In some embodiments, the at least one energy saving pattern may be at least one of the one or more energy saving patterns that is associated with the lowest power consumption of the RU at the current load.

In some embodiments, an energy saving operation and/or power domain may be associated with at least one of: a CPU; one or more L1BFs; one or more DFEs; one or more RX-AFEs; one or more TX-AFEs; and one or more TRX. In some embodiments, an energy saving operation may be an operation associated with at least one of: CFR adjustment; TRX channel shutdown; TRX channel standby; TRX shutdown; DFE clock gating; DFE channel standby; DFE channel shutdown; DFE shutdown; L1BF clock gating; L1BF shutdown; PA VDD adjustment; PA bias adjustment; PA blinking; PA shutdown; LNA blinking; DVFS; ASIC dynamic clock gating; Data bus speed optimization; DPD disabling; and LAN blinking. In some embodiments, the network node may comprise at least one of: SMO; BBU; and DU.

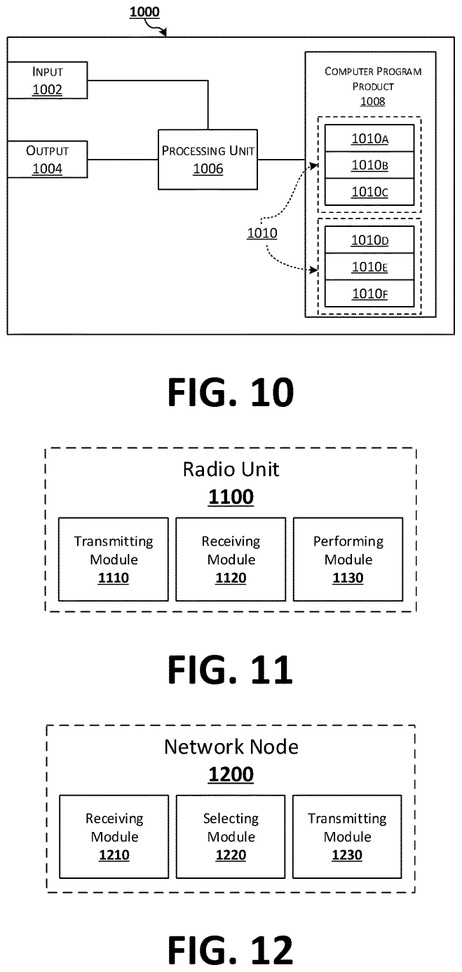

FIG. 10 schematically shows an embodiment of an arrangement 1000 which may be used in a server or a terminal device according to an embodiment of the present disclosure. Comprised in the arrangement 1000 are a processing unit 1006, e.g., with a Digital Signal Processor (DSP) or a Central Processing Unit (CPU). The processing unit 1006 may be a single unit or a plurality of units to perform different actions of procedures described herein. The arrangement 1000 may also comprise an input unit 1002 for receiving signals from other entities, and an output unit 1004 for providing signal(s) to other entities. The input unit 1002 and the output unit 1004 may be arranged as an integrated entity or as separate entities.

Furthermore, the arrangement 1000 may comprise at least one computer program product 1008 in the form of a non-volatile or volatile memory, e.g., an Electrically Erasable Programmable Read-Only Memory (EEPROM), a flash memory and/or a hard drive. The computer program product 1008 comprises a computer program 1010, which comprises code/computer readable instructions, which when executed by the processing unit 1006 in the arrangement 1000 causes the arrangement 1000, the RU, and/or the network node in which it is comprised to perform the actions, e.g., of the procedure described earlier in conjunction with FIG. 2, FIG. 6, FIG. 8, and/or FIG. 9 or any other variant.

The computer program 1010 may be configured as a computer program code structured in computer program modules 1010A, 1010B, and 1010C. Hence, in an exemplifying embodiment when the arrangement 1000 is used in an RU for energy saving, the code in the computer program of the arrangement 1000 includes: a module 1010A configured to transmit, to a network node, a first message indicating one or more energy saving patterns supported by the RU; a module 1010B configured to receive, from the network node, a second message indicating at least one energy saving pattern selected from the one or more energy saving patterns; and a module 1010C configured to perform one or more energy saving operations associated with the selected at least one energy saving pattern.

The computer program 1010 may be configured as a computer program code structured in computer program modules 1010D, 1010E, and 1010F. Hence, in an exemplifying embodiment when the arrangement 1000 is used in a network node for facilitating an RU in energy saving, the code in the computer program of the arrangement 1000 includes: a module 1010D configured to receive, from the RU, a first message indicating one or more energy saving patterns supported by the RU; a module 1010E configured to select at least one of the one or more energy saving patterns; and a module 1010F configured to transmit, to the RU, a second message indicating the selected at least one energy saving pattern.

The computer program modules could essentially perform the actions of the flow illustrated in FIG. 2, FIG. 6, FIG. 8, and/or FIG. 9, to emulate the RU and/or the network node. In other words, when the different computer program modules are executed in the processing unit 1006, they may correspond to different modules in the RU and/or the network node.

Although the code means in the embodiments disclosed above in conjunction with FIG. 10 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor.

The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the RU and/or the network node.

Correspondingly to the method 800 as described above, an RU 1100 for energy saving is provided. FIG. 11 is a block diagram of an exemplary RU 1100 according to an embodiment of the present disclosure. The RU 1100 can be e.g., the RU 210.

The RU 1100 can be configured to perform the method 800 as described above in connection with FIG. 8. As shown in FIG. 11, the RU 1100 may comprise a transmitting module 1110 configured to transmit, to a network node, a first message indicating one or more energy saving patterns supported by the RU; a receiving module 1120 configured to receive, from the network node, a second message indicating at least one energy saving pattern selected from the one or more energy saving patterns; and a performing module 1130 configured to perform one or more energy saving operations associated with the selected at least one energy saving pattern.

The above modules 1110, 1120, and/or 1130 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 8. Further, the RU 1100 may comprise one or more further modules, each of which may perform any of the steps of the method 800 described with reference to FIG. 8.

Correspondingly to the method 900 as described above, a network node 1200 for facilitating an RU in energy saving is provided. FIG. 12 is a block diagram of an exemplary network node 1200 according to an embodiment of the present disclosure.

The network node 1200 can be e.g., the any of the RAN/SMO 200.

The network node 1200 can be configured to perform the method 900 as described above in connection with FIG. 9. As shown in FIG. 12, the network node 1200 may comprise a receiving module 1210 configured to receive, from the RU, a first message indicating one or more energy saving patterns supported by the RU; a selecting module 1220 configured to select at least one of the one or more energy saving patterns; and a transmitting module 1230 configured to transmit, to the RU, a second message indicating the selected at least one energy saving pattern.

The above modules 1210, 1220, and/or 1230 can be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 9. Further, the network node 1200 may comprise one or more further modules, each of which may perform any of the steps of the method 900 described with reference to FIG. 9.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

| Abbreviation | Explanation |
|---|---|
| AFE | Analog Front End |
| BB | Baseband |
| DFE | Digital Front End |
| DU | Digital Unit |
| EE | Energy Efficiency |
| KPI | Key Performance Indicator |
| L1BF | Layer 1 Beamforming |
| RU | Radio Unit |
| SMO | Service Management and |
| | Orchestration |

1.-34. (canceled)

35. A method performed by a Radio Unit (RU) configured to operate in a network, the method comprising:
transmitting, to a network node, a first message indicating one or more energy saving patterns supported by the RU;
receiving, from the network node, a second message indicating at least one energy saving pattern selected from the supported one or more energy saving patterns; and
performing one or more energy saving operations associated with the selected at least one energy saving pattern.

36. The method of claim 35, wherein at least one of the supported one or more energy saving patterns is associated with multiple domains.

37. The method of claim 36, wherein the multiple domains include at least one of the following: time domain, frequency domain, amplitude domain, and space domain.

38. The method of claim 35, wherein each of the supported one or more energy saving patterns is associated with a combination of energy saving operations that can be performed simultaneously.

39. The method of claim 38, wherein the combination of energy saving operations comprises one or more energy saving operations for each of multiple power domains, including at least one of the following power domains:
Central Processing Unit (CPU);
Layer 1 Beam Former (L1BF);
Digital Front End (DFE);
Receiver Analog Front Ends (RX-AFE);
Transmitter Analog Front Ends (TX-AFE); and
Transceiver (TRX).

40. The method of claim 35, wherein the first message further indicates at least one of the following for at least of the supported energy saving patterns:
one or more loads, and
respective energy consumption values associated with the one or more loads.

41. The method of claim 40, wherein the one or more loads are respective Physical Resource Block (PRB) loads, and each PRB load is indicated by a ratio of a number of used PRBs to a number of total PRBs.

42. The method of claim 35, wherein the one or more energy saving patterns supported by the RU are pre-configured or hardcoded.

43. The method of claim 35, wherein the one or more energy saving patterns supported by the RU are dynamically determined by the RU based on at least of the following: a current load, and one or more RU hardware capabilities.

44. The method of claim 43, further comprising, before transmitting the first message, receiving from the network node a third message indicating the current load.

45. The method of claim 35, wherein the one or more energy saving operations are performed on at least one of the following hardware:
a Central Processing Unit (CPU);
one or more Layer 1 Beam Formers (L1BFs);
one or more Digital Front Ends (DFEs);
one or more receiver Analog Front Ends (RX-AFEs);
one or more transmitter Analog Front Ends (TX-AFEs); and
one or more Transceivers (TRXs).

46. The method of claim 35, wherein the one or more energy saving operations performed include at least one of the following:
Crest Factor Reduction (CFR) adjustment;
Transceiver (TRX) channel shutdown;
TRX channel standby;
TRX shutdown;
Digital Front End (DFE) clock gating;
DFE channel standby;
DFE channel shutdown;
DFE shutdown;
Layer 1 Beam Former (L1BF) clock gating;
L1BF shutdown;
Power Amplifier (PA) VDD adjustment;
PA bias adjustment;
PA blinking;
PA shutdown;
Low Noise Amplifier (LNA) blinking;
Dynamic Voltage and Frequency Scaling (DVFS);
Application Specific Integrated Circuit (ASIC) dynamic clock gating;
Data bus speed optimization;
Digital Pre-distortion (DPD) disabling; and
Local Area Network (LAN) blinking.

47. A radio unit (RU) configured to operate in a network, the RU comprising:
one or more processors; and
memory operably coupled to the one or more processors and having stored therein instructions that, when executed by the one or more processors, cause the RU to:
transmit, to a network node, a first message indicating one or more energy saving patterns supported by the RU;
receive, from the network node, a second message indicating at least one energy saving pattern selected from the supported one or more energy saving patterns; and
perform one or more energy saving operations associated with the selected at least one energy saving pattern.

48. A method performed by a network node to facilitate energy saving by a Radio Unit (RU), the method comprising:
receiving, from the RU, a first message indicating one or more energy saving patterns supported by the RU;
selecting at least one of the supported one or more energy saving patterns; and
transmitting, to the RU, a second message indicating the selected at least one energy saving pattern.

49. The method of claim 48, wherein each of the supported one or more energy saving patterns is associated with a combination of energy saving operations that can be performed simultaneously by the RU.

50. The method of claim 48, the first message further indicates at least one of the following for at least of the supported energy saving patterns:
one or more loads, and
respective energy consumption values associated with the one or more loads.

51. The method of claim 50, wherein the one or more loads are respective Physical Resource Block (PRB) loads, and each PRB load is indicated by a ratio of a number of used PRBs to a number of total PRBs.

52. The method of claim 48, wherein the at least one of the supported one or more energy saving patterns is selected based on at least one of the following: one or more Key Performance Indicators (KPIs), and a current load.

53. The method of claim 52, wherein the selected at least one energy saving pattern is associated with a lowest power consumption of the RU at the current load.

54. The method of claim 52, further comprising, before receiving the first message, transmitting to the RU a third message indicating the current load.
